(19) United States
(12) Patent Application Publication
(10) Pub. No.: US 2006/0225336 A1
(43) Pub. Date: Oct. 12, 2006

(54) System and Method for Reducing Bycatch

(76) Inventor: Andrew Redfearn, Queensland (AU)

Correspondence Address: BEUSSE BROWNLEE WOLTER MORA & MAIRE, 390 N. ORANGE AVENUE, SUITE 2500, ORLANDO, FL, 32801, US

(21) Appl. No.: 11/277,774

(22) Filed: Mar. 29, 2006

Related U.S. Application Data
(60) Provisional application No. 60/670,557, filed on Apr. 12, 2005.

(51) Int. Cl. A01K 73/02

(52) U.S. Cl. 43/9.2

(57) ABSTRACT

Disclosed herein is a system for catching shrimp that minimizes bycatch. The system implements a guiding light feature that directs fish to an escape opening strategically placed in the net.

### BACKGROUND

The worldwide shrimp fishing industry is facing serious economic and environmental problems. Increasing environmental regulations, especially those aimed at reducing the mortality of non-targeted species, is negatively affecting the shrimping industry. The environmental problem relating to non-targeted species arises from the large quantities of non-targeted species of fin fish, as well as turtles, which are caught together with shrimp when using presently available trawling apparatus and often returned dead to the sea. Much of this catch, termed bycatch, is made up of juveniles of commercially valuable species, which are thus wasted. Regulatory actions to reduce this waste problem are rapidly increasing.

Most shrimp are caught by otter trawls towed behind trawlers. The otter trawl was introduced to the shrimp fishing industry in 1912 and has undergone few changes since its inception. Basically, the otter trawl is a large funnel made of mesh netting. Extending from the mouth of the funnel are two mesh extensions, one on either side, that are designed to guide shrimp into the mouth of the net. At the narrow rear end of the net is located the collecting bag, called a codend.

Conventional fishing trawl can be compared to a big funnel made from net-meshes of different sizes. It has a big opening at one end and narrows down into the trawl bag at the other end where the fish is collected. The trawl is towed after the fishing vessel. Big trawl doors connected by warps to the vessel, floats and bobbins fastened to the fishing line and the foot rope keeps the trawl open. Marine species in the track of the trawl opening that can not swim faster than the trawl is towed by the vessel are caught in the trawl and finally land in the trawl bag.

One of the pre-requisition for sustainable fishing is that governments grant individual quotas, most often to fishing vessels, based on total allowable catches of individual species in their territorial waters. The granted quota, specifies marine species and quantities allocated to the vessel. A vessel is not permitted to land species not included in its quota, unless it is a non quota species. The same is valid for fishes below certain size or weight. The regulations for allocations of quoata can vary from one country to another between fishing grounds and seasons. [xx how are bigger fish distinguished from smaller fish in the fishing industry.

Conventional fishing trawl is not designed to differentiate between fish species and it can be difficult to guaranty that fish below certain size does not land in the trawl bag. Mesh sizes in the aft-part of the trawl can deform considerably when fish is collected in the bag and it can then be difficult for small and juvenile fishes to escape through the net meshes. All this results in that small and non quota species are thrown back into the sea. Fish that lands in trawl bag is most often damaged in their scale beyond healing.

In recent years increased interest has been on developing fishing gear that could sort out marine-species that are not to be caught. Such fishing gear would support sustainable development of the marine resources of the sea.

Although the otter trawl was a dramatic advancement to the shrimp fishing industry, nevertheless it has always been troubled with numerous disadvantages: for example, high drag, which increases fuel consumption of the trawler as well as limits towing speed, with the consequent reduction in the amount of area which can be covered per unit of time; difficulty in maintaining the net on the sea bottom at higher speeds (which can be partially corrected by using heavier otter doors, but at the expense of increased drag); the necessity for periodically hauling in the net, emptying it, and recasting it; the need to employ a separate net to determine the presence or absence of shrimp in the water through which the otter net is being drawn; the liability of shrimp and non-targeted species being dead when hauled in; and the difficulty for non-targeted species (bycatch) to escape. As to this last shortcoming, a great effort has been made to solve this problem through the inclusion of turtle exclusion devices (TED) and bycatch reduction devices (BRD), but limited success has been attained. At present, even the most sophisticated otter trawl still suffers from the aforementioned deficiencies because of the inherent limitations of its basic concept.

The solution, then, is to provide a new trawling system and trawl device which will catch more shrimp and kill less bycatch, thus resulting in cost economies and reducing the negative impact on the environment.

### BRIEF DESCRIPTION OF THE DRAWINGS

FIG. 1 shows a side view of a prior art trawling net system

FIG. 2 is a side view of a trawling net system embodiment that reduces bycatch.

FIG. 3 is a side view of a net system embodiment that reduces bycatch.

### DETAILED DESCRIPTION

The subject invention is based on the inventor's discovery that conventional bycatch reduction systems still lack a practical and feasible solution to reducing the undesired killing of bycatch fishes. The inventor has discovered that the use of at least one strategically placed light coupled to a trawling net can be implemented to direct small undesired fish out of net allowing them to escape from being caught and unnecessarily killed.

According to one embodiment, the subject invention pertains to a shrimp net comprising a mouth, a guiding panel, a grid positioned at the distal end of the guiding panel, an escape hatch for large sea creatures and a cod end at the distal end of said net. The net system also includes a conduit having a first end and a second end, wherein the first end of the conduit fluidly communicates with the net and second end has a light proximate thereto, effective to allow undesired fish to escape the net. Most shrimp harvesting occurs at night. As fish are caught in the net, they become disoriented by the dark and the turbulence of the net. The inventor has discovered that fish under such conditions will naturally gravitate for a strategically placed light. Thus, the light acts as an “exit sign” for the fin fish to swim through the conduit toward the light, once they reach the light, they are leaving the conduit and therefore safely exit the net.

The conduit may in its most basic sense be an opening in the net. In other embodiments, the conduit is a tube, pipe, duct or some other passageway. The conduit is positioned in the net such that it creates a flow through the opening in the net to current enough current and/or turbulence in the net to prevent shrimp from escaping but to allow fish, which instinctively flow against current, are able to escape. Typically, the conduit is pointed toward the direction the net is being pulled such that current flows through the conduit.

In another embodiment, the invention pertains to a net with an opening and a scoop strategically placed and effective to create a current through the opening to prevent the escape of shrimp but to allow escape of small fish. Preferably, a light is positioned on or proximate to the scoop to attract fish through the opening.

According to another embodiment, the subject invention is directed toward a method of netting shrimp that minimizes undesired bycatch. The method includes providing a net suitable for catching shrimp, providing an opening in the net that allows for undesired fish to escape, and positioning a light at the outer side of the opening such that undesired fish are directed toward the opening and allowed to safely escape from the net.

FIG. 1 shows a typical prior art shrimp trawling net 100. The net 100 comprises a mouth 105, a guiding panel 110 that corrals fish and shrimp toward a grid 115. The net also comprises an escape hatch 120 upstream from the grid 115. Larger fish, turtles and other sea creatures caught in the net are stopped by the grid 115 and allowed to escape out the escape hatch 120. Smaller fish and shrimp go past the grid 115 and ultimately are corralled into the cod end of the net 122.

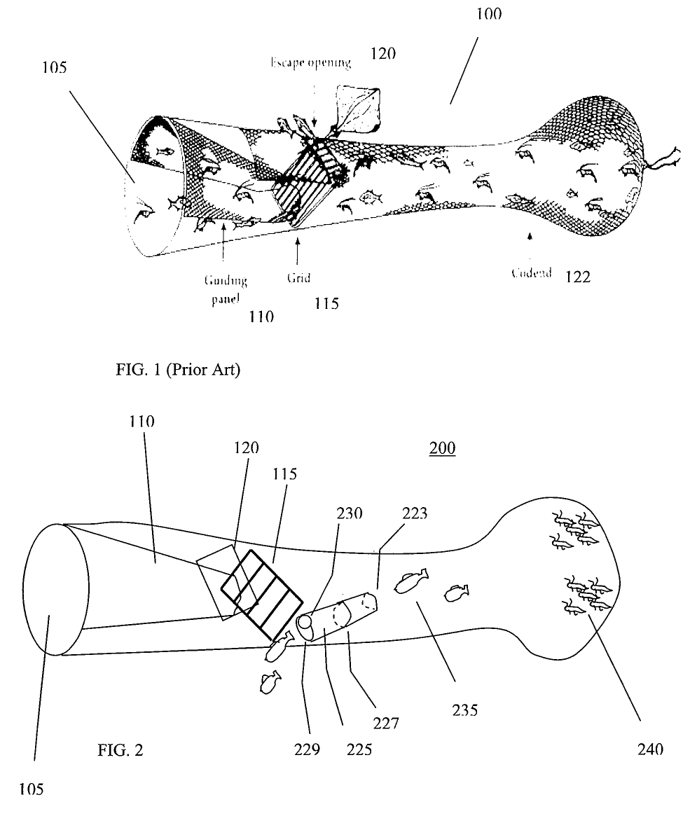

FIG. 2 shows one bycatch reducing net 200 according to an embodiment of the subject invention. The net 200 comprises a mouth 105, a guiding panel 110, grid 115 and escape hatch 120 commonly found on conventional nets. The net 200 also has associated therewith a conduit 225 with a light 230 positioned at its upstream end 229. The conduit 225 passes through an opening 227 in the net 200. Current is produced through the conduit 225 as a natural result of its orientation and the direction the net 200 is being pulled. Fish 235 in the net may overcome the current to pass through the downstream end 223 of the conduit 225 and out the upstream end 229 of the conduit. However, the current is sufficient to hold shrimp 240 in the net 200. As discussed herein, the light 230 may be repositioned to optimize its placement for drawing fish out of the net 200 without interfering with the current and pathway of the fish 235. It may be placed just past the upstream end 229 of the conduit 225 or closer to the opening 227.

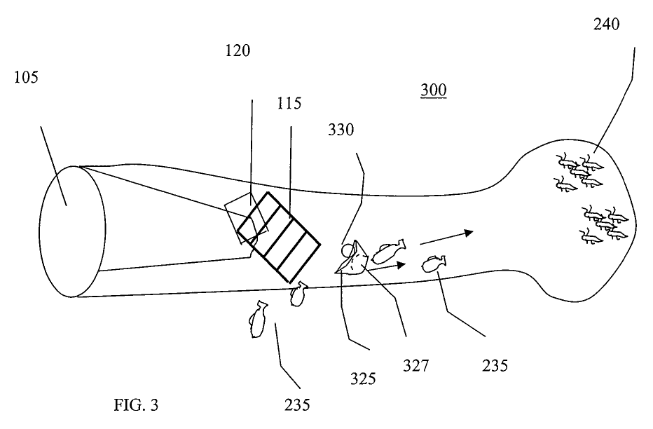

FIG. 3 shows an alternate net embodiment 300. The net 300 comprises a mouth 105, a guiding panel 110, grid 115 and escape hatch 120 commonly found on conventional nets. The net 300 comprises an opening 327 and a scoop 325 to direct current through the opening 327. Positioned proximate to the scoop 325 is a light 330. Current flows through the opening 327 (see arrows) such that fish 235 are able to overcome the current as they are attracted through the opening 327 by the light 330 while shrimp 240 are maintained in the net 300.

Nets according to the subject invention may have one or more opening with conduits and/or scoops positioned near the openings to further maximize the reduction of bycatch. In another embodiment, the subject invention pertains to a bycatch reduction kit comprising a scoop or conduit and a light for implementation into a net. The kit may include instructions for installing the bycatch reduction kit, Easterners, line and/or tools. Lights used as the attractant in the system typically will be water proof and powered by rechargeable batteries. In alternative embodiments, the lights are run off electricity from the boat which is provided by an electrical line. In another embodiment, the light may be powered, or batteries recharged, by water current such as through the implementation of a turbine or similar rotating means.

Finally, while various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims. The teachings of all patents and other references cited herein are incorporated herein by reference to the extent they are not inconsistent with the teachings herein.

What is claimed is:

1. A method of netting shrimp that minimizes undesired bycatch, the method comprises providing a net suitable for catching shrimp, providing an opening in the net that allows for undesired fish to escape, and positioning a light at the outer side of the opening such that undesired fish are directed toward the opening and allowed to safely escape from the net.

2. A shrimp net comprising a mouth, a guiding panel, a grid positioned at the distal end of the guiding panel, an escape hatch for large sea creatures and a cod end at the distal end of said net, said net further comprising a conduit having a first end and a second end, wherein the first end of the conduit fluidly communicates with the net and second end has a light proximate thereto, effective to encourage undesired fish to escape the net.

3. A shrimp net comprising a mouth, a guiding panel, a grid positioned at the distal end of the guiding panel, an escape hatch for large sea creatures and a cod end at the distal end of said net, said net further comprising a an opening, a scoop associated with said opening to direct current through said opening, and a light proximate to said opening effective to attract undesired fish to the opening for escaping the net.

4. A bycatch reduction kit for installation into a shrimp net comprising at least one scoop or conduit and a battery powered, water-proof light.

5. The kit of claim 4 further comprising instructions for installing said scoop or conduit onto said shrimp net.
